(19) United States
(12) Patent Application Publication
(10) Pub. No.: US 2015/0302313 A1
(43) Pub. Date: Oct. 22, 2015

(54) METHOD OF PREDICATING ULTRA-SHORT-TERM WIND POWER BASED ON SELF-LEARNING COMPOSITE DATA SOURCE

(71) Applicants: State Grid Corporation of China, Beijing (CN); Gansu Electric Power Company of State Grid, Lanzhou (CN); Wind Power Technology Center of Gansu Electric Power Company, Lanzhou (CN)

(72) Inventors: NING-BO WANG, Beijing (CN); LIANG LU, Beijing (CN); XU-SHAN HAN, Beijing (CN); ZI-FEN HAN, Beijing (CN); HUAI-SEN JIA, Beijing (CN); XIAO-YONG WANG, Beijing (CN); RONG HUANG, Beijing (CN); JIN-PING ZHANG, Beijing (CN)

(21) Appl. No.: 14/682,121

(22) Filed: Apr. 9, 2015

(30) Foreign Application Priority Data
Apr. 22, 2014 (CN) 201410163004.1

(51) Int. Cl. G06N 7/00; G06F 17/50

(52) U.S. Cl. CPC G06N 7/00; G06F 17/5009

(57) ABSTRACT

A method of predicating ultra-short-term wind power based on self-learning composite data source includes following steps. Model parameters of an autoregression moving average model are obtained by inputting data. A predication result is obtained by inputting data required by wind power predication into the autoregression moving average model. A post-evaluation is performed to the predication result by analyzing error between the predication result and measured values, and performing model order determination and model parameters estimation again while the error is greater than an allowable maximum error.

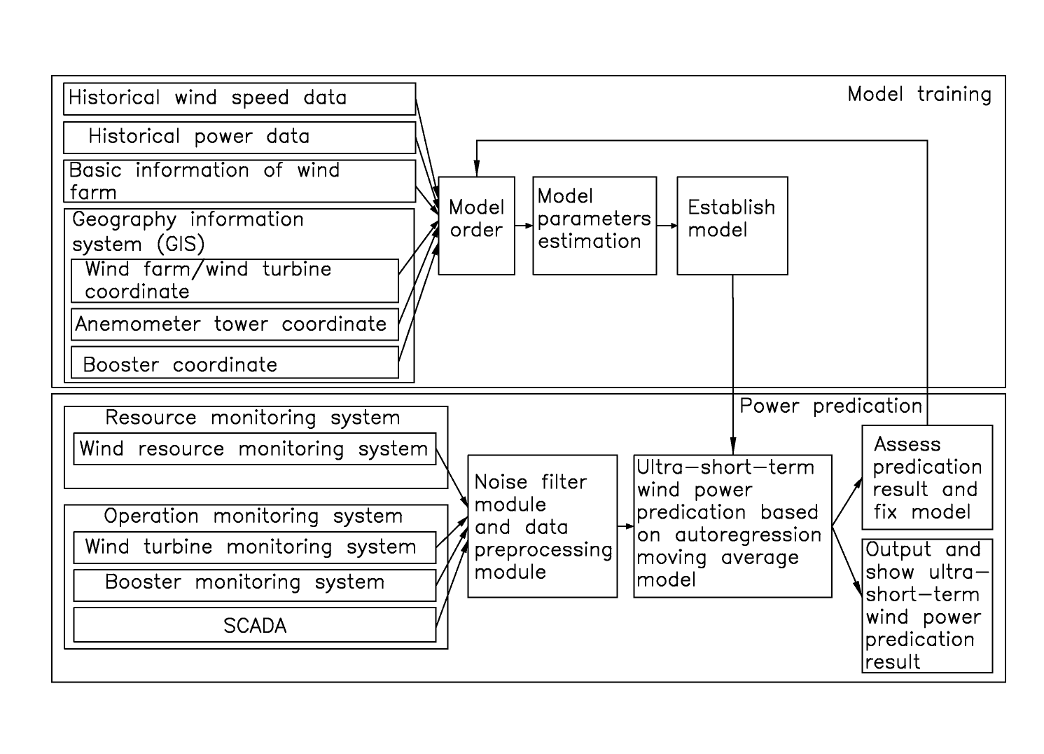

This application claims all benefits accruing under 35 U.S.C. §119 from China Patent Application 201410163004.1, filed on Apr. 22, 2014 in the China Intellectual Property Office, disclosure of which is incorporated herein by reference.

### BACKGROUND

1. Technical Field

The present disclosure relates to a method of predicating ultra-short-term wind power based on self-learning composite data source.

2. Description of the Related Art

With the rapid development of wind power industry, China has entered a period of rapidly developing wind power. Large-scale wind power bases are usually located in the “Three North” (Northwest, Northeast, Northern China) of China.

With development of new energy, uncertainty and uncontrollability of wind power and photovoltaic brings to many problems to the security and stability of economic operation of the grid. The wind power predication is the basis for large-scale wind power optimization scheduling. The wind power predication can provide critical information for real-time scheduling of new energy , recent plan of new energy, monthly plan of new energy, generation capacity of new energy, and abandoned wind power

What is needed, therefore, is a method of predicating ultra-short-term wind power based on self-learning composite data source.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

The only FIGURE shows a flowchart of one embodiment of a method of predicating ultra-short-term wind power based on self-learning composite data source.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

Referring to the FIGURE, one embodiment of a method of predicating ultra-short-term wind power based on self-learning composite data source comprises:

first step, obtaining model parameters of an autoregression moving average model by inputting data;

second step, obtaining a predication result by inputting data required by wind power predication into the autoregression moving average model; and

third step, performing post-evaluation to the predication result by analyzing error between the predication result and measured values, and performing model order determination and model parameters estimation again while the error is greater than an allowable maximum error.

The method of predicating ultra-short-term wind power can be divided into two stages: the first stage, training model; and the second stage, predicating wind power. The first stage comprises the first step, and the second step. The second stage comprises the third step.

In first step, the model parameters of the autoregression moving average model can be obtained by:

(a), inputting basic data of model training;

(b), determining model order; and

(c), estimating the parameters of model via moment estimation method.

In step (a), the basic data of model training comprises wind farm's basic information, historical wind speed data, historical power data, and geographic information system data.

In step (b), the model order is determined by:

determining model order by using the residual variance map, wherein xₜ is assumed as the item to be estimated, and xₜ₋₁, xₜ₋₂, . . . , xₜ₋ₙ is the known historical power sequence; for the ARMA (p, q) model, the determining model order is to determine the value of the model parameters p and q;

fitting the original sequence with a series of progressively increasing order model, calculating residual sum of squares \hat{σ}ₐ², and drawing the order and graphics of \hat{σ}ₐ², wherein while the order increase, \hat{σ}ₐ² decreases dramatically; while the order reaches actual order, \hat{σ}ₐ² is gradually leveled off, or even increase,

\hat{σ}ₐ²=Squares of fitting error/((number of actually observed values)−(number of model parameters));

wherein the number of actually observed values is the observed values which applied in the fitting model; in a sequence with N observed values, the maximum number of observed values is N−p in fitting AR(p) model; the number of model parameters is the number of parameters applied in constructing model; while the model comprises mean values, the number of model parameters equals to the number of order plus one; In the sequence with N observed values, the ARMA model residuals estimator is:

$${\hat{σ}}_{a}^{2} ( p , q ) = \frac{Q ( \hat{μ} , {\hat{ϕ}}_{1} , … , {\hat{ϕ}}_{p} , {\hat{θ}}_{1} , … , {\hat{θ}}_{q} )}{( N - p ) - ( p + q + 1 )} ;$$

wherein Q is a sum of squares of fitting error; φᵢ(1≦i≦p) and θⱼ(1≦j≦q) are model coefficients; N is a length of observed sequence; \hat{μ} is a constant of model parameters, and determined by φᵢ(1≦i≦p) and θⱼ(1≦j≦q)

In the step (c), the estimating the parameters of ARMA (p,q) model via moment estimation method comprises:

defining the historical power data of wind farm as a data sequence x₁, x₂, . . . , xₜ, and autocovariance of x₁, x₂, . . . , xₜ is defined as:

$${\hat{γ}}_{k} = \frac{1}{n} {\sum }_{t = k + 1}^{n} {x}_{t} {x}_{t - k} ,$$

wherein k=0, 1, 2, . . . , n−1, xₜ and xₜ₋ₖ are values in the sequence x₁, x₂, . . . , xₜ; then

$${\hat{γ}}_{0} = \frac{1}{n} {\sum }_{t = 1}^{n} {x}_{t}^{2} .$$

The autocorrelation function of historical power data is:

$${\hat{ρ}}_{k} = \frac{{\hat{γ}}_{k}}{{\hat{γ}}_{0}} = \frac{\frac{1}{n} {\sum }_{t = k + 1}^{n} {x}_{t} {x}_{t - k}}{\frac{1}{n} {\sum }_{t = 1}^{n} {x}_{t}^{2}} = \frac{{\sum }_{t = k + 1}^{n} {x}_{t} {x}_{t - k}}{{\sum }_{t = 1}^{n} {x}_{t}^{2}} ,$$

wherein k=0, 1, 2, . . . , n−1.

The moments estimation of the AR is:

$$[ \begin{matrix}{ϕ}_{1} \\ {ϕ}_{2} \\ … \\ {ϕ}_{p}\end{matrix} ] = {[ \begin{matrix}{\hat{ρ}}_{q} & {\hat{ρ}}_{q - 1} & … & {\hat{ρ}}_{q - p + 1} \\ {\hat{ρ}}_{q + 1} & {\hat{ρ}}_{q} & … & {\hat{ρ}}_{q - p + 2} \\ … & … & … & … \\ {\hat{ρ}}_{q + p - 1} & {\hat{ρ}}_{q + p - 2} & & {\hat{ρ}}_{q}\end{matrix} ]}^{- 1} [ \begin{matrix}{\hat{ρ}}_{q + 1} \\ {\hat{ρ}}_{q + 2} \\ … \\ {\hat{ρ}}_{q + p}\end{matrix} ] ;$$

assuming:

yₜ=x₁−φ₁xₜ₋₁− . . . −φₚxₜ₋ₚ;

thus a covariance function is:

$$\begin{matrix}{γ}_{k} ( {y}_{t} ) = E ( {y}_{t} {y}_{t + k} ) \\ = E [ ( {x}_{t} - {ϕ}_{1} {x}_{t - 1} - … - {ϕ}_{p} {x}_{t - p} ) ( {x}_{t + k} - {ϕ}_{1} {x}_{t + k - 1} - … - {ϕ}_{p} {x}_{t + k - p} ) ] \\ = {\sum }_{i , j = 0}^{n} {ϕ}_{i} {ϕ}_{j} {γ}_{k + j - i} ;\end{matrix}$$

substituting γₖ with estimate of \hat{γ}ₖ:

$${γ}_{k} ( {y}_{t} ) = {\sum }_{i , j = 0}^{n} {ϕ}_{i} {ϕ}_{j} {\hat{γ}}_{k + j - i} ,$$

thus parameters φ₁, φ₂, . . . , φₚ can be obtained;

applying moments estimation to the model parameters θ₁, θ₂, . . . , θ_{q} of model MA(q):

γ₀(yₜ)=(1+θ₁²+θ₂²+ . . . +θ_{q}²)σₐ²,

until

γₖ(yₜ)=(−θₖ+θ₁θₖ₊₁+ . . . +θ_{q-k}θ_{q})σₐ²,

wherein k=1, 2, . . . , m;

the model parameters of the autoregression moving average model of the m+1 nonlinear equations listed above can be resolved via iteration.

In detail, the equation can be transformed as:

$${σ}_{a}^{2} = {γ}_{0} \text{/} ( 1 + {θ}_{1}^{2} + {θ}_{2}^{2} + … + {θ}_{q}^{2} ) ;$$

$${θ}_{k} = - \frac{{γ}_{k}}{{σ}_{a}^{2}} + {θ}_{1} {θ}_{k + 1} + … + {θ}_{q - k} {θ}_{q} , \\ k = 1 , 2 , … , m ;$$

giving a group of initial values of θ₁, θ₂, . . . , θ_{q} and σₐ² such as:

θ₁=θ₂= . . . =θ_{q}=0, σₐ²=γ₀;

substituting the initial values into the right side of the two equations listed above, the left is the first iterative value in the first iterative step, and defined as σₐ²⁽¹⁾, θ₁⁽¹⁾, . . . , θ_{q}⁽¹⁾; then the σₐ²⁽¹⁾, θ₁⁽¹⁾, . . . , θ_{q}⁽¹⁾ again, the left is the second iterative value, and defined as σₐ²⁽²⁾, θ₁⁽²⁾, . . . , θ_{q}⁽²⁾; going on iteration, while the results of the adjacent two iterations is less than a given threshold, the results are obtained as the approximate solution of parameters.

From solving process listed above, in order to obtain the order of the time series model, it is necessary to obtain the predictive value of the time series forecasting; in order to get the predictive value of a time series, it is necessary to establish specific prediction function; in order to establish specific prediction function, it is necessary to obtain the order of model.

According to practical results, the order of time series model is generally not more than five bands. So in the implementation of the algorithm, it can assume that the model has one order, and get a first-order model parameters from parameters estimation method, thereby the estimated function can be obtained, then the predictive value of each item of time series model in the first-order model, thus a first-order residual variance model can be obtained; then, assuming the model is a second-order model, and obtain the second-order model residuals via the above method; and so on, the residuals of 1-5 order model can be obtained, and selected the minimum order residuals model number as the final order of the model. After determine the model order, the parameters θ₁, θ₂, . . . , θ_{q} can be calculated.

In the second step, the obtaining a predication result by inputting data required by wind power predication into the autoregression moving average model comprises:

(a), inputting basic data of power prediction;

(b), dealing with the basic data via filtering and preprocessing;

(c), establishing autoregressive moving average model based on the certain parameters, and inputting the basic data after being dealt with into the autoregressive moving average model to obtain prediction result;

(d), outputting the predication result to the database, showing the prediction results by charts and curves, and showing the results of comparing prediction results and measured results.

In one embodiment, the basic data comprises resource monitoring system data and operational monitoring system data. The resource monitoring system data comprises wind resource monitoring system resource monitoring data; the operation monitoring system data comprises fans data, booster station data, and supervisory control and data acquisition system (SCADA).

In one embodiment, the dealing with the basic data via filtering and preprocessing comprises: the noise filter module filter the data obtained from the real-time acquisition monitoring system in order to remove bad data and singular value; data preprocessing module deal with the data via alignment, normalization, and classification filtering process.

After the model parameters are estimated, the time series model of ultra-short-term wind power forecasting can be obtained by combined the model parameters and order of the model has been estimated. The autoregression moving average model can be established in accordance with p and q values, as well as the value φ₁, φ₂, . . . , φₚ and θ₁, θ₂, . . . , θ_{q}.

The autoregressive moving average model can be:

$${X}_{t} = {\sum }_{i = 1}^{p} {ϕ}_{i} {X}_{t - i} + {\sum }_{t = 1}^{q} {θ}_{i} {α}_{t - i} + {α}_{t} ,$$

wherein φᵢ(1≦i≦p) and θⱼ(1≦j≦q) are coefficients, αₜ is white noise sequence.

The ultra-short-term wind power prediction accuracy is effectively improved due to the fact the composite data source is introduced, and thus the on-grid energy of new energy resources is effectively increased on the premise that safe, stable and economical operation of a power grid is guaranteed.

Depending on the embodiment, certain of the steps of methods described may be removed, others may be added, and that order of steps may be altered. It is also to be understood that the description and the claims drawn to a method may include some indication in reference to certain steps. However, the indication used is only to be viewed for identification purposes and not as a suggestion as to an order for the steps.

It is to be understood that the above-described embodiments are intended to illustrate rather than limit the disclosure. Variations may be made to the embodiments without departing from the spirit of the disclosure as claimed. It is understood that any element of any one embodiment is considered to be disclosed to be incorporated with any other embodiment. The above-described embodiments illustrate the scope of the disclosure but do not restrict the scope of the disclosure.

What is claimed is:

1. A method of predicating ultra-short-term wind power based on self-learning composite data source, the method comprising:
obtaining model parameters of an autoregression moving average model by inputting data;
obtaining a predication result by inputting data required by wind power predication into the autoregression moving average model; and
performing post-evaluation to the predication result by analyzing error between the predication result and measured values, and performing model order determination and model parameters estimation again while the error is greater than an allowable maximum error.

2. The method of claim 1, wherein the model parameters of the autoregression moving average model is obtained by:
inputting basic data of model training;
determining a model order; and
estimating the model parameters via moment estimation method.

3. The method of claim 2, wherein the basic data of model training comprises wind farm's basic information, historical wind speed data, historical power data, and geographic information system data.

4. The method of claim 2, wherein the model order is determined by:
determining the model order by using a residual variance map, wherein xₜ is assumed as an item to be estimated, and xₜ₋₁, xₜ₋₂, . . . , xₜ₋ₙ is the known historical power sequence; for a ARMA (p, q) model, the determining model order is to determine values of the model parameters p and q;
fitting an original sequence with a series of progressively increasing order model, calculating residual sum of squares \hat{σ}ₐ², and drawing the order and graphics of \hat{σ}ₐ², wherein while the order increase, \hat{σ}ₐ² decreases dramatically; while the order reaches actual order, \hat{σ}ₐ² is gradually leveled off, or even increase,
\hat{σ}ₐ²=Squares of fitting error/((number of actually observed values)−(number of model parameters));
wherein a number of actually observed values are observed values which applied in the fitting model; in a sequence with N observed values, the maximum number of observed values is N−p in fitting AR(p) model; the number of model parameters is the number of parameters applied in constructing model; while the model comprises mean values, the number of model parameters equals to the number of order plus one; In the sequence with N observed values, the ARMA model residuals estimator is:
$${\hat{σ}}_{a}^{2} ( p , q ) = \frac{Q ( \hat{μ} , {\hat{ϕ}}_{1} , … , {\hat{ϕ}}_{p} , {\hat{θ}}_{1} , … , {\hat{θ}}_{q} )}{( N - p ) - ( p + q + 1 )} ;$$
wherein Q is a sum of squares of fitting error; φ₁(1≦i≦p) and θⱼ(1≦j≦q) are model coefficients; N is a length of observed sequence; \hat{μ} is a constant of model parameters, and determined by φ₁(1≦i≦p) and θⱼ(1≦j≦q).

5. The method of claim 4, wherein the estimating the parameters of ARMA (p,q) model via moment estimation method comprises:
defining the historical power data of wind farm as a data sequence x₁, x₂, . . . , xₜ, and autocovariance of x₁, x₂, . . ., xₜ is defined as:
$${\hat{γ}}_{k} = \frac{1}{n} {\sum }_{t = k + 1}^{n} {x}_{t} {x}_{t - k} ,$$
wherein k=0, 1, 2, . . . , n−1, xₜ and xₜ₋ₖ are values in the sequence x₁, x₂, . . . , xₜ; then
$${\hat{γ}}_{0} = \frac{1}{n} {\sum }_{t = 1}^{n} {x}_{t}^{2} .$$

6. The method of claim 5, wherein an autocorrelation function of historical power data is:
$${\hat{ρ}}_{k} = \frac{{\hat{γ}}_{k}}{{\hat{γ}}_{0}} = \frac{\frac{1}{n} {\sum }_{t = k + 1}^{n} {x}_{t} {x}_{t - k}}{\frac{1}{n} {\sum }_{t = 1}^{n} {x}_{t}^{2}} = \frac{{\sum }_{t = k + 1}^{n} {x}_{t} {x}_{t - k}}{{\sum }_{t = 1}^{n} {x}_{t}^{2}} ,$$
wherein k=0, 1, 2, . . . , n−1.

7. The method of claim 6, wherein the moments estimation of the AR is:
$$[ \begin{matrix}{ϕ}_{1} \\ {ϕ}_{2} \\ … \\ {ϕ}_{p}\end{matrix} ] = {[ \begin{matrix}{\hat{ρ}}_{q} & {\hat{ρ}}_{q - 1} & … & {\hat{ρ}}_{q - p + 1} \\ {\hat{ρ}}_{q + 1} & {\hat{ρ}}_{q} & … & {\hat{ρ}}_{q - p + 2} \\ … & … & … & … \\ {\hat{ρ}}_{q + p - 1} & {\hat{ρ}}_{q + p - 2} & & {\hat{ρ}}_{q}\end{matrix} ]}^{- 1} [ \begin{matrix}{\hat{ρ}}_{q + 1} \\ {\hat{ρ}}_{q + 2} \\ … \\ {\hat{ρ}}_{q + p}\end{matrix} ] ;$$
assuming:
yₜ=x₁−φ₁xₜ₋₁− . . . −φₚxₜ₋ₚ;
thus a covariance function is:
$$\begin{matrix}{γ}_{k} ( {y}_{t} ) = E ( {y}_{t} {y}_{t + k} ) \\ = E [ ( {x}_{t} - {ϕ}_{1} {x}_{t - 1} - … - {ϕ}_{p} {x}_{t - p} ) ( {x}_{t + k} - {ϕ}_{1} {x}_{t - 1} - … - {ϕ}_{p} {x}_{t + k - p} ) ] \\ = {\sum }_{i , j = 0}^{n} {ϕ}_{i} {ϕ}_{j} {γ}_{k + j - i} ;\end{matrix}$$
substituting γₖ with estimate of \hat{γ}ₖ:
$${γ}_{k} ( {y}_{t} ) = {\sum }_{i , j = 0}^{n} {ϕ}_{i} {ϕ}_{j} {\hat{γ}}_{k + j - i} ,$$
thus parameters φ₁, φ₂, . . . , φₚ is obtained;
applying moments estimation to the model parameters θ₁, θ₂, . . . , θ_{q} of model MA(q):
γ₀(yₜ)=(1+θ₁²+θ₂²+ . . . +θ_{q}²)σₐ²,
until
γₖ(yₜ)=(−θₖ+θ₁θₖ₊₁+ . . . +θ_{q-k}θ_{q})σₐ²,
wherein k=1, 2, . . . , m;
the model parameters of the autoregression moving average model of the m+1 nonlinear equations listed above is resolved via iteration.

8. The method of claim 7, wherein the obtaining a predication result by inputting data required by wind power predication into the autoregression moving average model comprises:
inputting basic data of power prediction;
dealing with the basic data via filtering and preprocessing; and
establishing autoregressive moving average model based on the certain parameters, and inputting the basic data after being dealt with into the autoregressive moving average model to obtain prediction result.

9. The method of claim 8, further comprises outputting the predication result to a database, showing the prediction results by charts and curves, and showing the results of comparing prediction results and measured results.

10. The method of claim 9, wherein the basic data comprises resource monitoring system data and operational monitoring system data, and the resource monitoring system data comprises wind resource monitoring system resource monitoring data; the operation monitoring system data comprises fans data, booster station data, and supervisory control and data acquisition system.

11. The method of claim 9, wherein the dealing with the basic data via filtering and preprocessing comprises: the noise filter module filter the data obtained from the real-time acquisition monitoring system to remove bad data and singular value; data preprocessing module deal with the data via alignment, normalization, and classification filtering process.

12. The method of claim 1, wherein utoregressive moving average model is expressed as:
$${X}_{t} = {\sum }_{i = 1}^{p} {ϕ}_{i} {X}_{t - i} + {\sum }_{t = 1}^{q} {θ}_{i} {α}_{t - i} + {α}_{t} ,$$
φ₁(1≦i≦p) and θⱼ(1≦j≦q) are coefficients, αₜ are white noise sequence.
